(19) United States
(12) Patent Application Publication
(10) Pub. No.: US 2006/0168533 A1
(43) Pub. Date: Jul. 27, 2006

(54) System and method for providing an indication of what part of a screen is being shared

(75) Inventors: Everett Yip, Bellevue, WA (US); Jeremy Max Stevens, Seattle, WA (US); Kanchan Mitra, Woodinville, WA (US); Kenneth Wickes, Seattle, WA (US); Kyle Krum, Seattle, WA (US)

Correspondence Address: PERKINS COIE LLP/MSFT, P. O. BOX 1247, SEATTLE, WA, 98111-1247, US

(73) Assignee: Microsoft Corporation, Seattle, WA (US)

(21) Appl. No.: 11/045,509

(22) Filed: Jan. 27, 2005

(51) Int. Cl. G06F 17/00; G06F 3/00; G06F 9/00

(52) U.S. Cl. 715/753

(57) ABSTRACT

A screen sharing indication system provides a presenter of a collaboration session an indication of what content being displayed on the presenter's computer screen is being shared with attendees during the collaboration session. Any part of the presenter's desktop or computer screen that are not being shared with the attendees is visually distinguished from the areas that are being shared. For example, the areas of the presenter's desktop that are not being shared and thus, are not visible by the attendees appear dimmed or grayed-out, cross-hatched, color shaded, etc., while the areas of the presenter's desktop that are being shared appear normal.

### TECHNICAL FIELD

The described technology is directed generally to collaboration services and, more particularly, to improving a presenter's sharing experience during a collaboration session.

### BACKGROUND

Today's global economy demands effective worldwide communication. For example, manufacturers often have suppliers located across the country and around the world. Timely and effective communication between the manufacturer and supplier can be critical to business success. In other cases, companies often assign business projects to work groups with members physically located around the world. In some situations, the work group members can belong to different organizations and/or companies. As with manufacturers and suppliers, timely and effective communication can be critical to the success of the work group.

Face-to-face meetings have been the traditional method of communicating, but, with the organizations becoming increasing geographically dispersed, these meetings often require travel on the part of attendees and, thus, are becoming increasingly time and cost prohibitive. With proliferation of computers and the advent of the Internet, and in particular, the maturing of the World Wide Web (“web”), these meetings are increasingly taking place virtually over computer networks through the use of electronic communication technologies, such as web meeting/conferencing and application sharing.

Application sharing technologies enable a sharing user, also referred to as a “presenter,” to share an application with various viewing users, also referred to as “attendees” or “participants.” The display produced by the application that is executing on the presenter's computer, and which is being shared, is made available via a connection, typically through a computer network, to the attendees' computers.

Application sharing allows a person—i.e., the presenter—to share a view of their desktop with other people. The portion of the desktop that is actually shared can change based on choices that the presenter of the application sharing session makes. When the presenter selects a window to share, the application sharing program typically shares the process associated with the selected window and, thus, all the windows associated with the process are shared. The images in the windows associated with the shared process are reconstructed in the attendees' computer displays, and the attendees will be able to see exactly what the presenter is seeing.

Even though electronic communication technologies provide many benefits, such as increased efficiency, there are, however, drawbacks with these technologies for application or image sharing. One drawback is a lack of a mechanism that enables the presenter to quickly know exactly what portions of the screen can be seen by attendees of the meeting. For example, if the presenter chooses to share an application, such as MICROSOFT WORD, it is sometimes difficult for the presenter to know what windows displayed on the screen is associated with the MICROSOFT WORD process and, thus, can be seen by the attendees. This may lead to inadvertent sharing of sensitive or confidential information that is not intended to be shared.

It would be desirable to have a technique that allows the presenter of an application sharing session to quickly know what portions of the screen are being shared with the attendees in order to enhance the presenter's sharing experience.

### BRIEF DESCRIPTION OF THE DRAWINGS

FIG. 1 is a block diagram illustrating selected components typically incorporated in at least some of the computer systems on which various embodiments of a screen sharing indication system may be implemented.

FIG. 2 is a high-level block diagram showing an environment in which the screen sharing indication system may operate.

FIG. 3 is a block diagram illustrating selected components of a presenter computer coupled to an attendee computer, according to some embodiments.

FIG. 4 is a display diagram illustrating a display of a desktop on a presenter computer, according to some embodiments.

FIG. 5 is a flow diagram illustrating the determination-of the screen area to dim, according to one embodiment.

FIG. 6 is a flow diagram illustrating the decoration painting, according to one embodiment.

FIG. 7 is a display diagram illustrating a sample shared window having a decoration indicating a sharing status, according to some embodiments.

### DETAILED DESCRIPTION

A method and system for providing a presenter of a collaboration session an indication of what content being displayed on the presenter's computer screen is being shared with attendees during the collaboration session is provided. Any part of the presenter's desktop or computer screen that is not being shared with the attendees is visually distinguished, for example, by “dimming,” cross-hatch, color shading, etc., from the part of the desktop that is being shared.

In one embodiment, any part of the presenter's desktop or computer screen that is not being shared with the attendees is “dimmed out.” Stated another way, the areas of the presenter's desktop that are not being shared and thus, are not visible by the attendees appear dimmed or grayed-out, while the areas of the presenter's desktop that are being shared appear normal. Alternatively, areas of the presenter's desktop that are not being shared can be painted over with a pattern such as “cross-hatch.” This visual distinction enables the presenter to quickly determine what potion of the screen—i.e., the contents that are displayed and visible on the screen—can be seen by the attendees.

For example, a sharing portion selection process executing on the presenter's computer determines the region of the desktop that is not being shared by calculating a “non-shared region.” At the start, the non-shared region starts out as the entire desktop area—i.e., the entire desktop display. The process then takes each window laid out on the desktop and, for each window, determines a “sharing region” for each window. The sharing region is the area or part of a shared window that is visible—i.e., not obscured by other overlaying windows—on the desktop. The sharing portion selection process calculates the area of the desktop to visually distinguish by removing the sharing regions from the non-shared region. After all the windows are processed, the resulting non-shared region defines the area of the desktop that is not being shared. In one embodiment, the sharing portion selection process overlays the desktop with the calculated non-shared region to dim the areas of the desktop that are not shared. Alpha-blending is one suitable technology that can be used to dim the pixel(s) in an area of the desktop. As is generally known, alpha-blending is a process for modifying the pixels—e.g., a black image is alpha-blended with partial transparency to achieve a dimming effect. The alpha value of a color controls its transparency. Enabling alpha blending allows colors, materials, and textures on a surface to be blended with transparency onto another surface.

In one embodiment, a “decoration” is placed in the title bar of any window that is being shared. The decoration generally refers to a visual indication which alerts its viewer—i.e., the presenter—that the window is currently being shared. The decoration may be drawn proximate to the window size controls and may comprise a simple text message and/or an icon indicating that the window is being shared, and may be seen by the attendees. In other embodiments, the decoration may be placed over some portion of the window that is being shared.

For example, a process executing on the presenter's computer determines which of the top-level windows or displays having title bars is currently being shared. For each top-level window that is being shared, the process appends a decoration painting routine to the end of each shared window's standard painting routine. The standard painting routine for the window is called by the operating system executing on the computer. For example, in MICROSOFT WINDOWS, every window has an associated procedure—i.e., a function that processes all messages sent or posted to all windows of the class. All aspects of a window's appearance and behavior depend on the window procedure's response to these messages. The decoration painting routine checks the current sharing status, such as running, paused, etc., of the window and, based on the current sharing status, causes the appropriate decoration to appear in the window's title bar.

For example, in MICROSOFT WINDOWS, the decoration painting routine can be implemented as a WINDOWS “hook” function. As is generally known, a “hook” contains or is made up of code that one program (in this case, the collaboration application) inserts into the WINDOWS message system of another application to access the message stream before other processing of the message takes place. Thus, the messages targeted to the application that has installed the hook will trigger the invocation of the hook function.

When a change in the sharing status occurs, the hook process replaces the decoration painting routine in each shared window's standard painting routine. The hook process also removes the decoration painting routine from the standard painting routine for the windows that were previously being shared but are no longer being shared. Subsequently, when the windows are painted/repainted on the screen, the decoration painting routine is executed, which causes the decoration to appear, for example, on the title bars of the windows that are being shared.

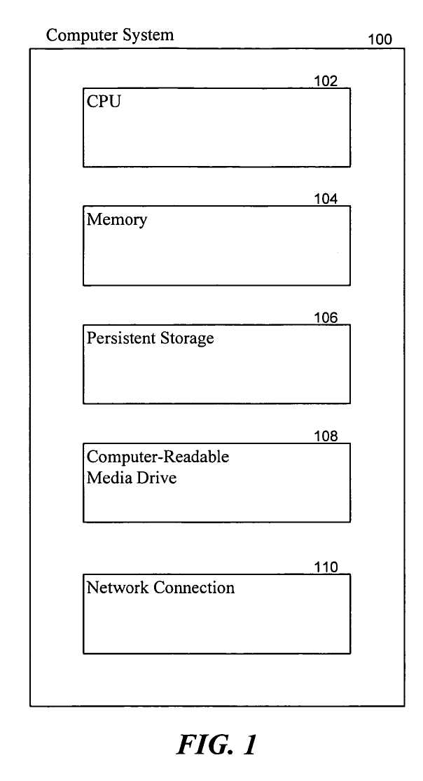

The various embodiments of the screen sharing indication system and their advantages are best understood by referring to FIGS. 1-7 of the drawings. The elements of the drawings are not necessarily to scale, emphasis instead being placed upon clearly illustrating the principles of the invention. Throughout the drawings, like numerals are used for like and corresponding parts of the various drawings.

FIG. 1 is a block diagram illustrating selected components typically incorporated in at least some of the computer systems on which various embodiments of a screen sharing indication system may be implemented. These computer systems 100 may include one or more central processing units (“CPUs”) 102 for executing computer programs; a computer memory 104 for storing programs and data-including data structures-while they are being used; a persistent storage device 106, such as a hard drive, for persistently storing programs and data; a computer-readable media drive 108, such as a CD-ROM drive, for reading programs and data stored on a computer-readable medium; and a network connection 110 for connecting the computer system to other computer systems, such as via the Internet, to exchange programs and/or data-including data structures. It will be appreciated that computer systems 100 may include one or more display devices for displaying program output, such as video monitors or LCD panels, and one or more input devices for receiving user input, such as keyboards, microphones, or pointing devices such as a mouse.

Embodiments of the screen sharing indication system may be implemented in various operating environments that include personal computers, server computers, hand-held or laptop devices, multiprocessor systems, microprocessor-based systems, programmable consumer electronics, digital cameras, network PCs, minicomputers, mainframe computers, distributed computing environments that include any of the above systems or devices, and so on. The computer systems may be cell phones, personal digital assistants, smart phones, personal computers, programmable consumer electronics, digital cameras, and so on.

The screen sharing indication system may be described in the general context of computer-readable instructions, such as program modules, executed by computer systems 100 or other devices. Generally, program modules include routines, programs, objects, components, data structures, etc. that perform particular tasks or implement particular abstract data types. Memory 104 and persistent storage device 106 are computer-readable media that may contain instructions that implement the facility. It will be appreciated that memory 104 and persistent storage 106 may have various other contents in addition to the instructions that implement the screen sharing indication system.

In the discussion that follows, various embodiments of the screen sharing indication system are further described in conjunction with a variety of illustrative examples. It will be appreciated that the embodiments of the screen sharing indication system may be used in circumstances that diverge significantly from these examples in various respects.

For example, even though various embodiments of the screen sharing indication system are described in conjunction with application sharing within a collaboration session, the screen sharing indication techniques are not to be limited to only application sharing sessions within a collaboration session. As such, one skilled in the art will appreciate that the described techniques can be adapted to work as a component of or in conjunction with various other applications which share information by causing windows displayed on one computer screen to be reproduced on another computer screen. Moreover, the application sessions, including the application sharing session, may exist independent of the collaboration session.

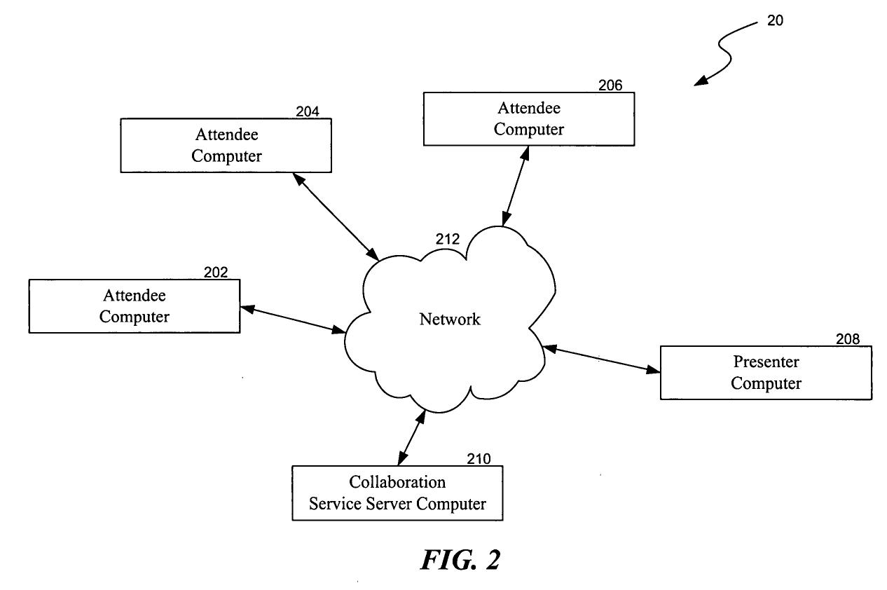

FIG. 2 is a high-level block diagram showing an environment 20 in which the screen sharing indication system may operate. As depicted, environment 20 comprises one or more attendee computers illustrated, by way of example, as computers 202, 204, and 206, a presenter computer 208, and a collaboration service server computer 210. In particular, computers 202, 204, 206, 208, and 210 are each coupled to one another through a network 212. As used herein, the terms “connected,” “coupled,” or any variant thereof, means any connection or coupling, either direct or indirect, between two or more elements; the coupling of connection between the elements can be physical, logical, or a combination thereof.

Computers 202, 204, 206, 208, and 210 are as discussed above more generally with respect to FIG. 1. In particular, the attendee computer is used by a user to attend or participate in a collaboration session, the presenter computer is used by a user to host or present the collaboration session, and the collaboration service server computer provides the collaboration service, such as MICROSOFT LIVE MEETING, by “hosting” the collaboration session.

Network 212 is a communications link that facilitates the transfer of electronic content between, for example, the attached computers. In one embodiment, network 206 includes the Internet. It will be appreciated that network 212 may be comprised of one or more other types of networks, such as a local area network, a wide area network, a point-to-point dial-up connection, and the like.

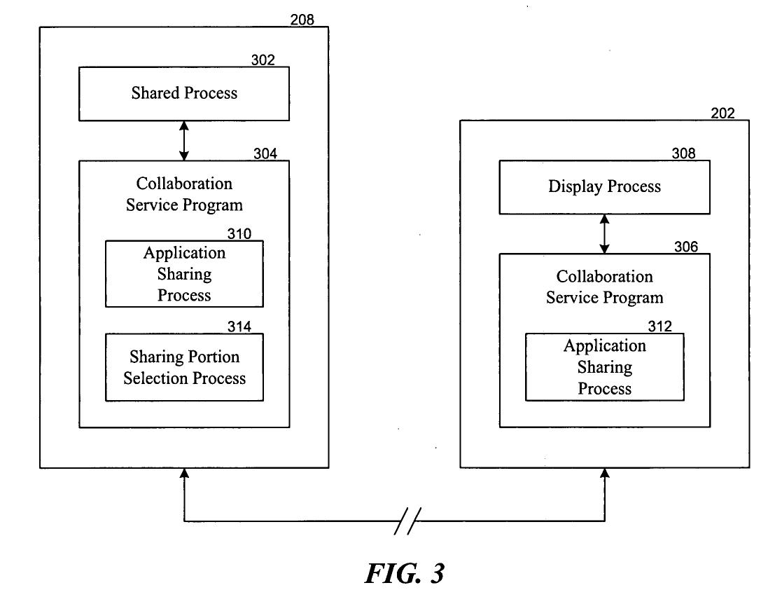

FIG. 3 is a block diagram illustrating selected components of presenter computer 208 coupled to attendee computer 202, according to some embodiments. One skilled in the art will appreciate that although only one attendee computer is illustrated in FIG. 3, this is not meant as a limitation to the actual number of attendee computers and that there can be more than one attendee computer in an implementation of the system, as illustrated by way of FIG. 2. Even though the presenter computer is illustrated as being coupled to the attendee computer, one skilled in the art will appreciate that the presenter and attendee computers may communicate with one another through the collaboration service server computer, as illustrated in FIG. 2. Alternatively, in embodiments where the collaboration service server computer is not present, the presenter and attendee computers may communicate directly with one another. In these embodiments, the collaboration service may be provided by the presenter computer.

As depicted, the presenter computer comprises one or more shared processes 302 and a collaboration service program 304, each of which is executing on the presenter computer. The collaboration service program on the presenter computer comprises an application sharing process 310 and a sharing portion selection process 314. The attendee computer comprises a collaboration service program 306 and a display process 308, each of which is executing on the attendee computer. The collaboration service program on the attendee computer comprises an application sharing process 312. The aforementioned components and processes of the presenter computer and the attendee computer are only illustrative, and one skilled in the art will appreciate that the computers may include other components and processes not depicted.

The shared processes include processes, such as word processing programs, from which information is being shared with one or more computers, such as the attendee computer. One skilled in the art will appreciate that the information generated by the shared processes need not be shared completely.

That is, the information shared by the presenter may be a subset of the information generated by a shared process. Moreover, many shared processes can also be used in a non-shared manner. For example, a word processing program may be used by the presenter for non-collaborative document production, and may then be used in a shared manner for group editing of the same or another document.

The collaboration service program allows the presenter to register with the collaboration service and to conduct the collaboration session. During the collaboration session, the presenter can initiate an application sharing session, for example, by selecting an icon in a user interface generated by the collaboration service program and displayed on the presenter computer's screen. This causes the application sharing process to start executing on the presenter computer, for example, as part of the collaboration service program. The application sharing process on the presenter computer may present the presenter a list of sharable applications on the presenter computer, including the shared process. The presenter may select the applications and/or documents to share in the application sharing session. Alternatively, the presenter may elect to specify a sharing frame, and share the information displayed within the sharing frame.

The application sharing process on the presenter computer is coupled to a counterpart application sharing process on the attendee computer. For example, the application sharing processes may be coupled via the network as depicted in FIG. 2, and the networking communications functionality may be provided by the collaboration service programs on the respective computers. Further, the application sharing process may transmit the shared information to the collaboration service server computer, which then transmits the shared information to each of the attendee computers.

In one embodiment, the sharing portion selection process dims out any part of the presenter's desktop that is not being shared with the attendees. Thus, the areas of the presenter's desktop display that are not being shared appear dimmed out, while the areas of the presenter's desktop display that are being shared appear normal. Moreover, the presenter's desktop display that is associated with—i.e., displayed by—the collaboration service program also appear normal even though the displayed content is not being shared with the attendees. This visual distinction—i.e., dimmed out vs. normal display—enables the presenter to quickly determine what content displayed on the desktop can be seen by the attendees.

In some embodiments, the sharing portion selection process may periodically execute. For example, a process, such as the collaboration service program or other process, executing on the presenter computer can periodically “poll” the sharing portion selection process. In other embodiments, the sharing portion selection process may be interrupt-driven. For example, the sharing portion selection process or other process executing on the presenter computer can detect a change in the desktop and invoke or cause the sharing portion selection process to execute.

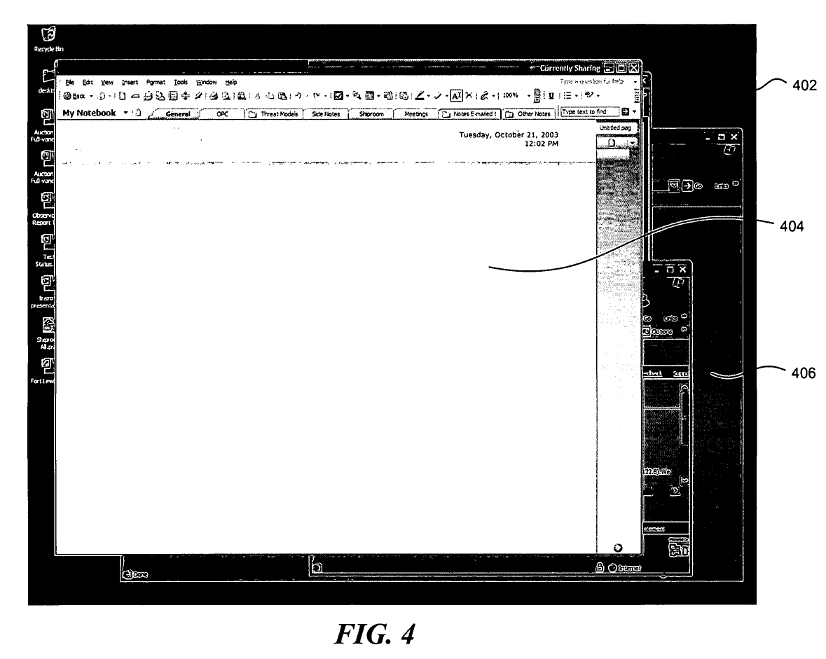

FIG. 4 is a display diagram illustrating a display of a desktop 402 on a presenter computer, according to some embodiments. The desktop illustrates the screen area of the presenter's primary monitor, and includes a shared window 404 and unshared windows 406. The contents displayed in the shared window are being shared with the attendees and thus, appear normal on the desktop to provide an indication to its viewer—i.e., the presenter—that these contents are visible by the attendees. In contrast, the contents displayed in the unshared windows are not being shared with the attendees and thus, appear dimmed out on the desktop to provide an indication to its viewer that the contents are not visible to the attendees. In other embodiments, various other visual indications, such as, by way of example, cross-hatching, etc., may be used to indicate to the viewer that these contents are not being shared.

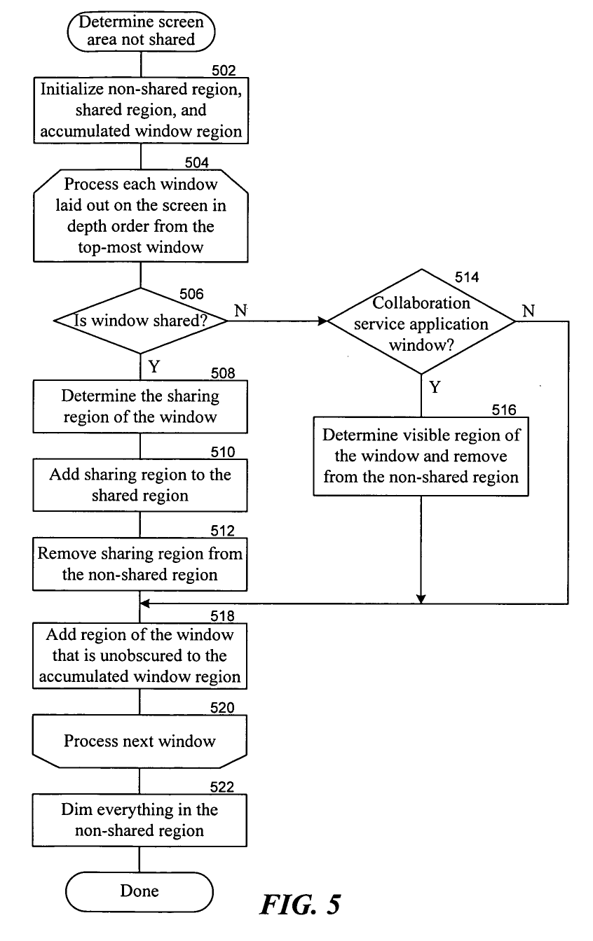

FIG. 5 is a flow diagram illustrating the determination of the screen area to dim, according to one embodiment. The sharing portion selection process may determine the area of the presenter's desktop to dim, and utilizes a shared region and an accumulated windows region to calculate/determine a non-shared region.

The three regions each represent the surface area of the desktop—i.e., the primary monitor. The calculated non-shared region indicates the areas or regions of the desktop that need to be distinguished—e.g., dimmed, cross-hatched, color shaded, etc. The shared region indicates the areas of the desktop that are being shared with the participants. The accumulated windows region represents the cumulated desktop area that has been processed at any point in time.

At step 502, the sharing portion selection process initializes the non-shared region, shared region, and accumulated windows region. The non-shared region is initialized to the entire desktop, and the shared region and the accumulated windows region are each initialized to “empty.” The sharing portion selection process, for each window laid out on the desktop, starting with the top-most window and proceeding in depth order (step 504), performs steps 506 to 518, until all the windows are processed (step 520). At step 506, the sharing portion selection process checks to determine if the window is being shared.

If the window is being shared, then, at step 508, the sharing portion selection process determines the sharing region of the window. The sharing region is the window region—i.e., the area of the window—less the accumulated windows region. This calculation accounts for the possibility that all or a portion of the window may be obscured by another window. The accumulated windows region will account for the possibly obscuring window because the windows are being processed in depth order, beginning with the top-most window.

At step 510, the sharing portion selection process adds the sharing region of the window to the shared region. The contents of the unobscured area of a shared window are being shared with the attendees. At step 512, the sharing portion selection process removes the sharing region of the window from the non-shared region.

If, at step 506, the sharing portion selection process determines that the window is not being shared, then, at step 514, the sharing portion selection process checks to determine whether the window is a collaboration service application window. Stated another way, the sharing portion selection process checks to determine whether the window was generated by the collaboration service application executing on the presenter computer. If the window is a collaboration service application window, then, at step 516, the sharing portion selection process determines the visible region of the window and removes the visible region from the non-shared region. Thus, the visible regions of the collaboration service application windows will not appear dimmed out on the desktop.

Subsequent to removing the visible region from the non-shared region, or determining that the window is not a collaboration service application window (step 514), or subsequent to removing the sharing region of the window from the non-shared region (step 512), the sharing portion selection process, at step 518 adds the region of the window that is unobscured to the accumulated window region, and proceeds to process the next top-most window (step 520).

At step 522, the sharing portion selection process dims out everything in the non-shared region. As a result, everything but the unobscured regions of the shared windows and the unobscured regions of the collaboration service application windows appear dimmed out on the desktop to indicate that these contents are not being shared with the attendees. The application sharing process can transmit the shared region—i.e., the content or areas in the shared region—to the attendee computers.

In embodiments where only the shared window(s) are to appear normal, processing steps 514 and 516 are omitted. Here, the collaboration service application windows are dimmed out because they are not being shared with the attendees.

In instances where a presenter uses a sharing frame to share information displayed on the desktop with the attendees, the sharing portion selection process dims out everything outside the sharing frame. In another embodiment, the sharing portion selection process may dim out everything outside the sharing frame except the unobscured regions of the collaboration service application windows. In this embodiment, the sharing frame and the unobscured regions of the collaboration service application windows appear normal, while the remaining areas of the desktop appear dimmed out.

One skilled in the art will appreciate that, for this and other processes and methods disclosed herein, the functions performed in the processes and methods may be implemented in differing order. Furthermore, the outlined steps are only exemplary, and some of the steps may be optional, combined with fewer steps, or expanded into additional steps without detracting from the essence of the invention.

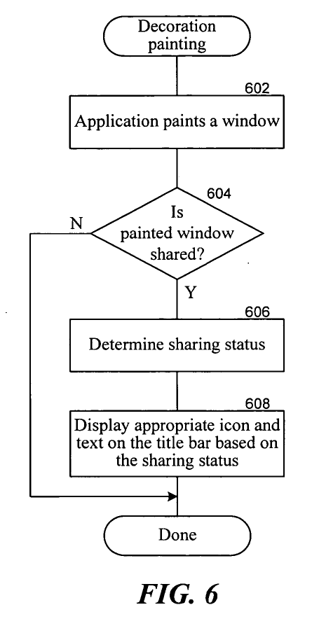

FIG. 6 is a flow diagram illustrating the decoration painting, according to one embodiment. At step 602, an application executing on the presenter computer paints a window. At step 604, a determination is made as to whether the window is being shared. If the window is not being shared, the decoration is not painted in the title bar for this window.

If the window is being shared, then, at step 606, the sharing status of the window is determined. In one embodiment, the application sharing process may provide the presenter the ability to start, stop, or pause the sharing of an application or application, or individual windows generated by an application. In this instance, the sharing status for a window may include “running” and “paused.” A running status for a window indicates that the contents displayed in the window are currently being shared. A paused status for a window indicates that sharing for this window has been temporarily stopped. At step 608, an appropriate icon and text is painted—i.e., displayed—in the title bar of the window based on its determined sharing status.

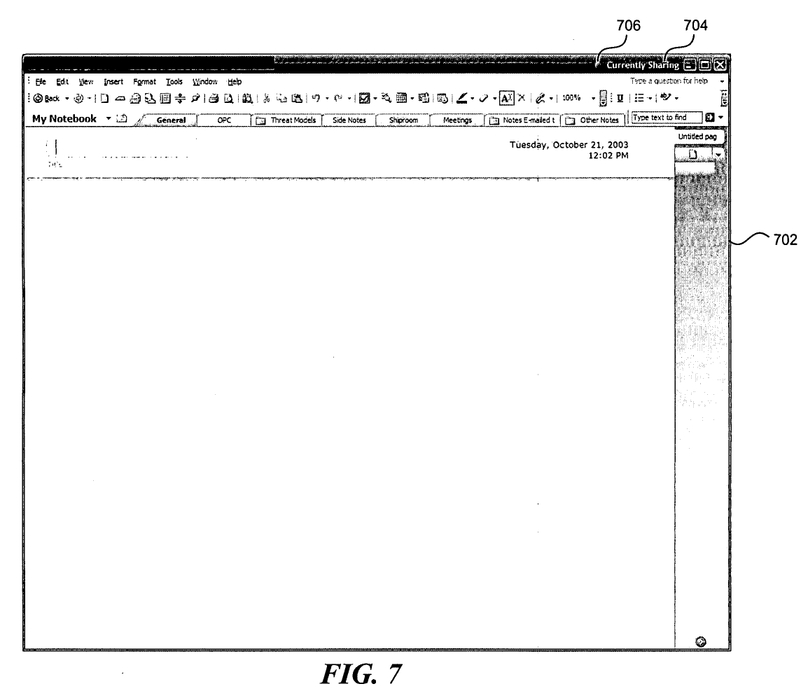

FIG. 7 is a display diagram illustrating a sample shared window 702 having a decoration indicating its sharing status, according to some embodiments.

As depicted, the window's sharing status is indicated by a text indication 704 and a color icon 706. The text indication provides a textual message as to the window's current sharing status. For example, the text indication may display “currently running” to indicate that the window is being currently shared, and “sharing paused” to indicate that the sharing for the window is currently paused. The color icon provides a color-keyed visual indication as to the window's current sharing status. For example, a green colored icon may indicate that the window is being currently shared, and a yellow colored icon may indicate that the sharing for the window is currently paused.

One skilled in the art will appreciate that either the text indication or the color icon may not be displayed in various embodiments. Moreover, the shape of the icon, the color of the icon, and the contents of the text indication may differ from the examples provided above.

From the foregoing, it will be appreciated that embodiments of the invention have been described herein for purposes of illustration, but that various modifications may be made without deviating from the spirit and scope of the invention. Accordingly, the invention is not limited except in accordance with elements explicitly recited in the appended claims.

We claim:

1. A computer-readable storage medium whose contents cause a computer system of a presenter of a collaboration session to determine areas of the computer system's screen not being shared with attendees during the collaboration session, such that the areas of the screen that are not being shared with attendees during the collaboration session are visually distinguished from the areas of the screen that are being shared with attendees during the collaboration session.

2. The computer-readable storage medium of claim 1 whose contents further cause the computer system to:
dim out the areas of the screen that are not being shared with attendees during the application sharing session; and
normally display the areas of the screen that are being shared with attendees during the application sharing session.

3. The computer-readable storage medium of claim 1 whose contents further cause the computer system to:
cross-hatch the areas of the screen that are not being shared with attendees during the application sharing session; and
normally display the areas of the screen that are being shared with attendees during the application sharing session.

4. The computer-readable storage medium of claim 1 whose contents further cause the computer system to:
color shade the areas of the screen that are not being shared with attendees during the application sharing session; and
normally display the areas of the screen that are being shared with attendees during the application sharing session.

5. The computer-readable storage medium of claim 1, wherein determining the areas of the screen not being shared with attendees during the application sharing session comprises calculating a non-shared region.

6. The computer-readable storage medium of claim 1, wherein determining the areas of the screen not being shared with attendees during the application sharing session comprises processing each window laid out on the screen in depth order from the top-most window.

7. The computer-readable storage medium of claim 1, wherein determining areas of the screen not being shared with attendees during the application sharing session comprises determining a sharing region of each window laid out on the screen, wherein the sharing region is the area of a shared window that is visible.

8. One or more computer memories collectively storing a data structure specifying a desktop display, the data structure comprising:
information specifying a first area of the desktop display being shared with attendees during an application sharing session; and
information specifying a second area of the desktop display not being shared with attendees during the application sharing session, the second area being distinct from the first area.

9. The computer memories of claim 8, wherein the first area is visually distinguished from the second area.

10. The computer memories of claim 8, wherein the second area is dimmed out.

11. The computer memories of claim 8, wherein the second area is cross-hatched.

12. One or more computer memories collectively storing a data structure specifying an application program window having a decoration over a portion of the window, wherein the window is being shared with attendees during an application sharing session, and further wherein the decoration being an indication of the window's current sharing status.

13. The computer memories of claim 12, wherein the decoration comprises a text message.

14. The computer memories of claim 12, wherein the decoration comprises a color icon.

15. The computer memories of claim 12, wherein the decoration indicates that the sharing for the window is currently paused.

16. The computer memories of claim 12, wherein the decoration indicates that the window is being currently shared.

17. The computer memories of claim 12, wherein the decoration is in a title bar of the window.
